(19) United States
(12) Patent Application Publication
(10) Pub. No.: US 2016/0032960 A1
(43) Pub. Date: Feb. 4, 2016

(54) Suction Support Device

(71) Applicants: Marvin Roy Feldman, Huixquilucan (MX); Po-Lin Liao, Taichung City (TW)

(72) Inventors: Marvin Roy Feldman, Huixquilucan (MX); Po-Lin Liao, Taichung City (TW)

(21) Appl. No.: 14/802,751

(22) Filed: Jul. 17, 2015

Related U.S. Application Data
(60) Provisional application No. 62/026,430, filed on Jul. 18, 2014.

(51) Int. Cl. F16B 47/00; F16M 13/02

(52) U.S. Cl. CPC F16B 47/006; F16M 13/022

(57) ABSTRACT

A suction device adapted to reliably support a force created by a person pulling on or otherwise using the device. Engaging an activating element allows a user to increase or reduce the vacuum generated by the device, the amount of which is visibly determinable using an indicator. Once in place, the activating element may be locked so as to prevent a user from inadvertently raising the activating element, and thereby reducing the suction generated by the device.

### CROSS REFERENCE TO RELATED APPLICATIONS

This application claims the benefit of U.S. Provisional Patent Application Ser. No. 62/026,430 filed Jul. 18, 2014.

### BACKGROUND OF THE INVENTION

The present invention is in the field of support or holding devices. More particularly, the present invention is in the field of support or grab bars. More specifically, the present invention is in the field of suction cup support bars.

Suction cups are used in a wide variety of applications including lifting and moving heavy materials or temporarily fixing an object to a flat surface. Moreover, it is not uncommon for them to be incorporated into devices intended to offer support to an elderly or otherwise feeble person. Indeed, these uses are well known in the art. For example, U.S. Pat. No. 7,603,728 issued to Roth discloses a Holding Device for Sanitary and More Particularly Bathroom Sector.

U.S. Pat. No. 8,234,725 issued to Roth discloses a handle arrangement that incorporates the use of suction cups and a vacuum loss indicator—actuated through mechanical means—to signal to a user of the handle arrangement if there has been a reduction of the vacuum.

U.S. Pat. No. 8,104,809 issued to Mayhugh discloses a manually activated suction pump on a suction cup suited for lifting windshields with the main aspect of the invention being a large handle on the suction cup which generates a suction force by lifting up on the handle.

U.S. Pat. No. 6,609,689 issued to Knapp discloses a wall mountable assembly suitable for holding towel bars, towel rings, and other accessories used around the household. It further discloses a means for locking the assembly from premature release via a releasable lock impeding the movement of a cam.

U.S. Pat. No. 7,004,521 issued to Ishii discloses a suction-holding device suited for moving large tiles made of stone materials which is operated by raising an operating handle upward to generate a strong suction force from the device.

U.S. Pat. No. 6,402,104 issued to Smith discloses a multi-utility mountable device capable of supporting a variety of bathroom accessories, such a toothbrush holder or soap dish.

What is missing in the art is a device which a user, typically of advanced age or who is physically handicapped, can reliably secure to a flat surface to support a pulling or pushing force generated by the user—such reliable characteristics comprising a clear and discernable indication (through color, visual, and textual means) as to when the device should likely be reapplied and a security feature to prevent premature, user-induced release of the device. Furthermore, there is a need for a suction support device that is capable of being easily connected to at least one additional suction support device to provide additional support.

The present invention addresses and overcomes these shortcomings.

### SUMMARY OF THE INVENTION

The present invention discloses a device that may be used to reliably support a force, and that communicates its holding effectiveness to a user, and prevents inadvertent, user-induced device failure. The device may be adjustably mounted to a flat surface to allow a user to remove the device from one area and reapply the device in a different area where support may be required. Because the device provides real-time information as to its vacuum holding power or effectiveness, a user may simply remove the device if it has insufficient holding power and reapply the device more securely to the flat surface. This, in turn, prevents the user from applying a force to the device that is greater than the device is capable of supporting with insufficient vacuum holding power.

More specifically, the present invention relates in one aspect to a suction device that may be used to support a pulling force. In one embodiment, the device is comprised of an activating element, a suction actuating element, at least one suction member, and a handle or other gripping surface. As a user engages the activating element, a force is exerted upon the suction actuating element thereby imparting a corresponding directional force on the suction member against a flat surface and creating a vacuum or suction force.

In another embodiment, a fluid transfer element may be used in conjunction with an indicator to communicate the device's holding power via a color-coded vacuum gauge. The colored regions of the vacuum gauge contain textual indications of the suction support device's holding power, such as “Holding” in a green region, “Reapply” in a yellow region, and “Unsafe” in a red region. Moreover, as an axial force is imparted on the activating element, the suction actuating element creates or eliminates an evacuated space between the device and the flat surface—and correspondingly increases or decreases the holding power (i.e., suction force) generated by the device on the flat surface—the effectiveness of which is communicated to the user via the indicator.

In yet another embodiment, a piston may be centrally located on the suction member and a spring may be concentrically aligned with the piston. As the user engages the activating element, a corresponding force is imparted to the piston and spring, thereby raising/lowering the piston and deflecting/releasing the spring. The raising and lowering of the piston correspondingly raises and lowers the at least one suction member. Such raising and lowering, when the at least one suction member is applied to a flat surface, thereby increases or decreases the holding power of the device.

In yet another embodiment, a guiding surface may be provided to facilitate a fluid motion of the activating element once engaged by the user. In one aspect of this embodiment, the guiding surface may be positioned between the activating element and the surface of the device body such that rotationally engaging the activating element causes a surface of the activating element to smoothly slide across the contact surface of the guiding surface.

In still another embodiment, the invention includes a piston, a spring, a tube, at least one suction member, an indicator, and a locking member. Given this, a user engages the activating element, which imparts motion on the piston, spring and at least one suction member. In one aspect of the embodiment, lifting the activating element would exert a downward force on the piston, spring, and at least one suction member, thus creating separation between the at least one suction member and a flat surface to which the device has been applied. Accordingly, a decrease in vacuum or holding power occurs and the device may be removed from the surface. In yet another aspect of the embodiment, more than one suction support device may be connected via a connector element.

In accordance with one aspect of this invention, a method for operating a suction device that may be used to support a force is provided. The suction device may include at least one suction member, an activating element, a suction activation member, an indicator, and a locking member. The method may include providing a suction support device having at least one suction member and positioning the at least one suction member onto a flat surface, then engaging an activating element so as to operate a suction actuating element; and locking the activating element using a locking member.

Other embodiments and aspects of the present invention will be apparent and are included within the scope of the present invention.

### BRIEF DESCRIPTION OF DRAWINGS

FIG. 1 depicts an isometric view of the suction support device with the handle in an up position.

FIG. 2 depicts an exploded view of the suction support device.

FIG. 3 depicts a profile view of the suction support device with the handle in an up position.

FIG. 4 depicts a cross sectional view of the suction support device shown in FIG. 3.

FIG. 5 depicts a top view of the suction support device with the handle in an up position.

FIG. 6 depicts a frontal view of the suction support device with the handle in an up position.

### DETAILED DESCRIPTION OF PREFERRED EMBODIMENTS

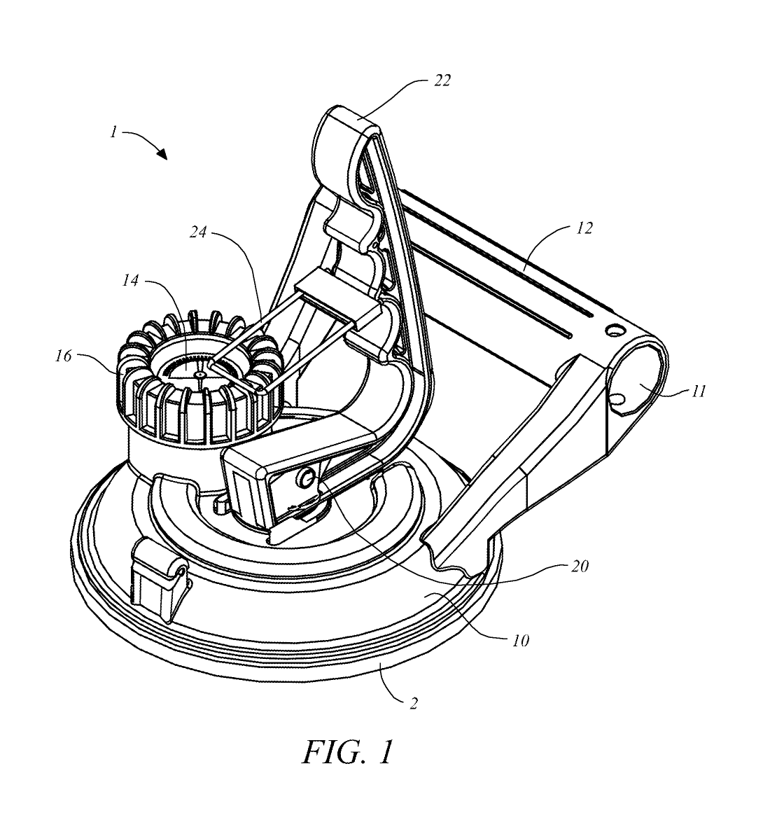

Referring first to FIG. 1, a suction support device 1 has a suction member 2. In a preferred embodiment, the suction member 2 is made from rubber or similar materials. The top side of the suction member 2 is encompassed by an associated body 10. A handle 12 is attached to the body 10. Body 10 also contains a cavity 9 (not shown) housing an indicator 14. An indicator cover 16 protects the exterior of indicator 14, the indicator cover 16 preferably being made of rubber or some other material capable of withstanding continual exposure to an aqueous environment. An activating element 22—shown in a raised position—is interconnected to the suction member 2 and pivotally rotates around a pin 20 when a raising or lowering force is applied to it. Raising and lowering the activating element 22 correspondingly causes the suction member 2 to be lowered or raised, respectively. Lowering the activating element 22 to its lowest position allows a rotatably-attached locking member 24 to be securely latched to the body 10.

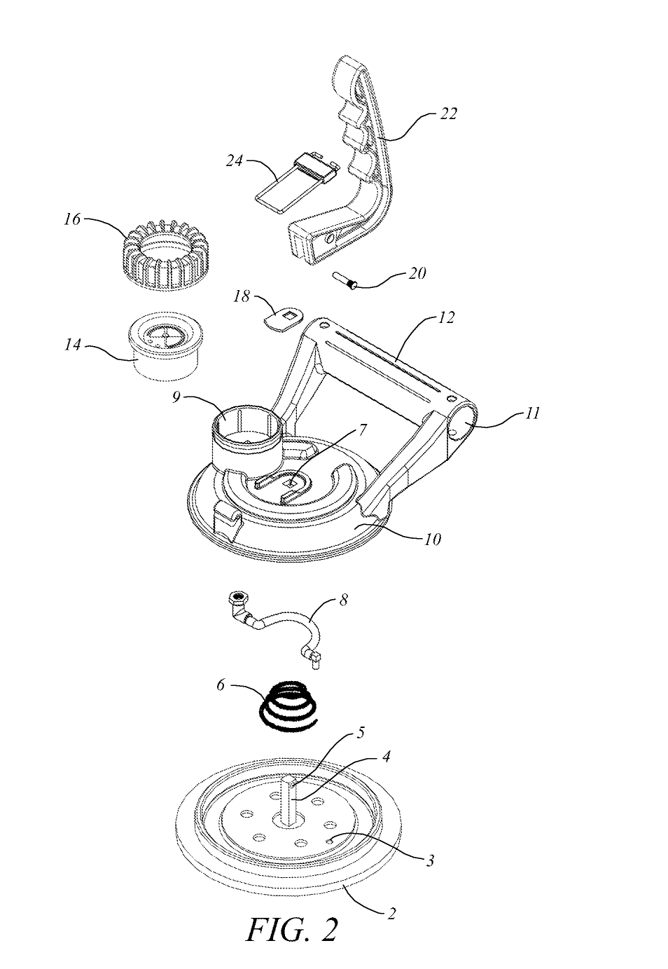

Referring now to FIG. 2, the suction support device 1 is depicted in an exploded view as can be seen in FIG. 2. A piston 4 is centrally located and mounted to the suction member 2, the piston 4 extending through an aperture 7 of the body 10. An opening 5 is horizontally disposed in the top of piston 4 for receiving a pin 20 to rotatably couple with an activating element 22. A spring 6 may be concentrically aligned with and surround the piston 4, and is enclosed between the suction member 2 and the body 10. A guiding surface 18 may be positioned between the activating element 22 and the body 10, which allows the activating element 22 to smoothly rotate during operation. As the activating element 22 is rotatably lowered, an upward force is applied to the piston 4 which in turn raises the suction member 2 and deflects the spring 6. Conversely, when the activating element 22 is raised, a downward force is applied to the piston 4, which lowers the suction member 2 to a position where the spring 6 is restored to an unbiased state. In operation, the suction support device 1 is firmly applied to a smooth, flat surface, and lowering the activating element 22 from the raised position imparts the upward force on the piston 4, which acts to pull the suction member 2 away from the surface, at which point a fluid, such as air or water, between the suction member 2 and the flat surface is sucked through an outlet 3 located on the suction member 2. This allows the fluid to travel through a tube 8 into the indicator 14 and creates an evacuated space between the suction member 2 and the flat surface. Once sufficient holding power is achieved—determinable via the indicator 14—a locking member 24, which is rotatably attached to the activating element 22, may be securely latched to the body 10.

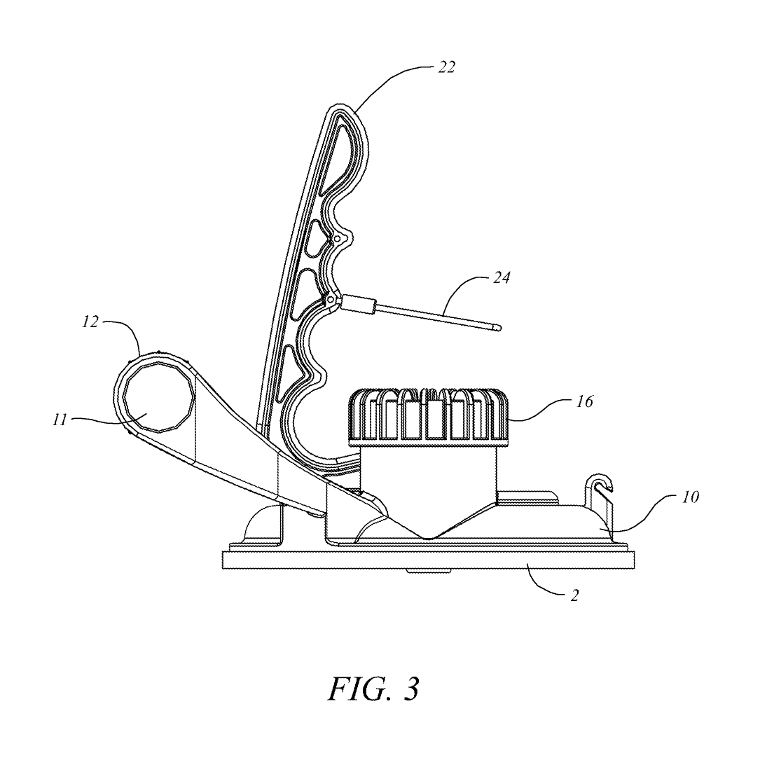

Referring now to FIG. 3, the suction support device 1 is shown in a profile view with the activating element 22 in the raised position. A cylindrical cavity 11 within the gripping portion of the handle 12 is readily apparent, which is capable of receiving a connector bar (not shown) that connectedly joins another suction support device 1 in a preferred embodiment, to allow for an extended gripping surface.

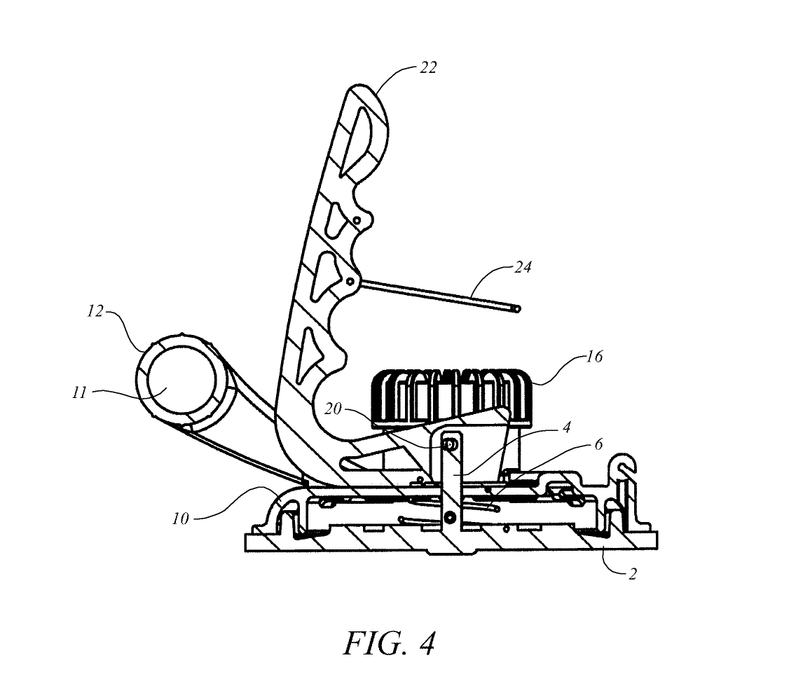

Referring now to FIG. 4, a cross-sectional view of the suction support device 1 shown in FIG. 3 is provided. Again, the activating element 22 is in the raised position and the spring 6 can be seen in an unbiased state.

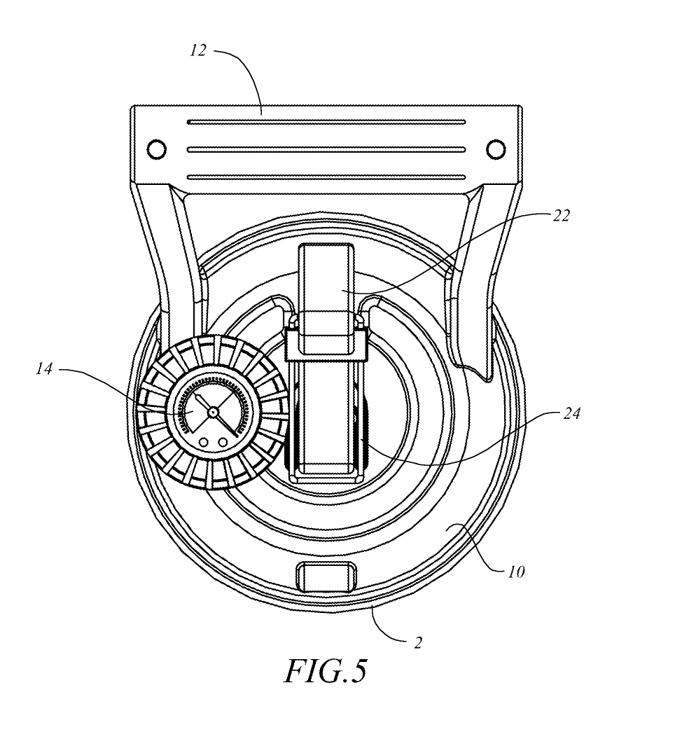

Referring now to FIG. 5, a top view of the suction support device 1 in the no-vacuum state (i.e., activating element 22 in the raised position) is shown. In this state, the indicator 14 provides feedback to a user that there is insufficient holding power (i.e., no vacuum).

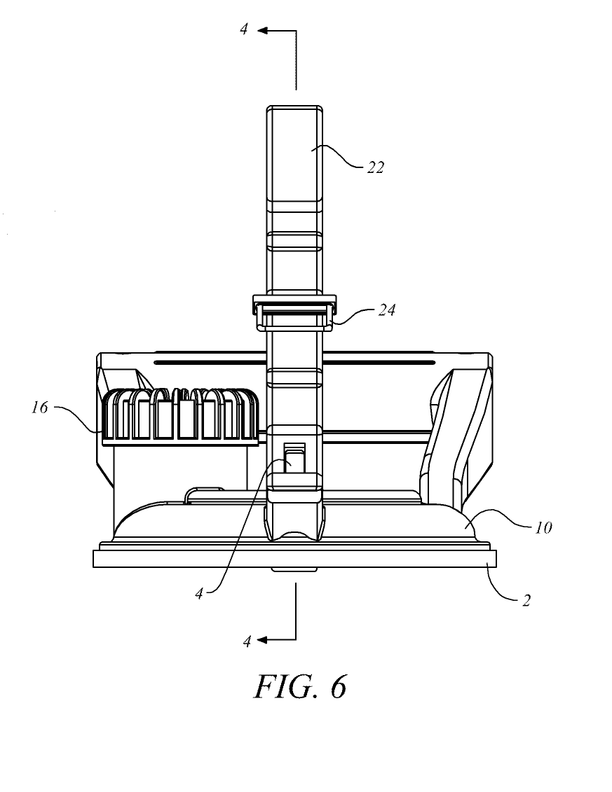

Referring now to FIG. 6, a frontal view shows the suction support device 1 in its no-vacuum state, in which state, the activating element 22 in the raised position and the piston 4 is visible from the front and is in its downward position.

Although the present invention has been described with reference to preferred embodiments, numerous modifications and variations can be made and still the result will come within the scope of the invention. No limitation with respect to the specific embodiments disclosed herein is intended or should be inferred. Each apparatus embodiment described herein has numerous equivalents.

I claim:

1. A suction support device comprising:
a suction member having a first side and a second side;
a suction actuating element interconnected to the second side of the suction member;
a body having a first surface, a second surface, and an aperture, wherein the body and the suction member encloses the suction actuating element;
an indicator interconnected to the suction actuating element;
a handle attached to the body; and
an activating element pivotally connected to the suction actuating element.

2. The suction support device of claim 1, the suction actuating element further comprising:
a piston having a first end and a second end, the first end of the piston is connected to the second side of the suction member;
a spring abutting the second side of the suction member;
an outlet located on the suction member, the outlet fluidly connecting the first and second sides of the suction member; and
a fluid transfer element between the outlet and the indicator;

3. The suction support device of claim 2, the fluid transfer element comprising:
a tube having a first end and a second end, wherein the first end is fitted to the indicator and the second end is fitted to the outlet on the second side of the at least one suction member.

4. The suction support device of claim 2, the piston rod centrally located on the second side of the suction member and the spring concentrically aligned with the piston.

5. The suction support device of claim 2, the tube is sealably fitted to the indicator and the outlet.

6. The suction support device of claim 2 further comprising a guiding surface positioned between the outer surface of the body and the activating element.

7. The suction support device of claim 2 further comprising a locking member rotatably secured to the activating element.

8. A suction support device according to claim 2, the indicator comprising stainless steel.

9. The suction support device of claim 2, the body further comprising a gripping surface.

10. The suction support device of claim 2, the device capable of connection to another suction support device with a connector bar.

11. The suction support device of claim 7 further comprising a safety latch capable of preventing inadvertent unlocking of the locking member.

12. A method for using a suction support device comprising the steps of:
providing a first suction support device having at least one suction member;
positioning at least one suction member onto a flat surface;
engaging an activating element so as to operate a suction actuating element; and
locking the activating element using a locking member.

13. The method of claim 12, wherein the suction actuating element comprises a piston, a spring and a tube.

14. The method of claim 12, wherein the locking member is rotatably secured to the activating element.

15. The method of claim 12 further comprising the steps of:
providing a second suction support device; and
connecting the first suction support device to the second suction support device.

16. The method of claim 15 wherein the first suction support device and second suction support device are connected via a connector bar.
